(19) United States
(12) Patent Application Publication
(10) Pub. No.: US 2024/0003482 A1
(43) Pub. Date: Jan. 4, 2024

(54) BENDABLE SUPPORT DEVICE

(71) Applicant: Primax Electronics Ltd., Taipei (TW)

(72) Inventors: Che-Wei Lee, Taipei (TW); Chin-Lung Chan, Taipei (TW); Yi-Hsien Lin, Taipei (TW)

(21) Appl. No.: 17/890,492

(22) Filed: Aug. 18, 2022

(30) Foreign Application Priority Data
Jul. 1, 2022 (TW) 111124740

(51) Int. Cl. F16M 11/10

(52) U.S. Cl. CPC F16M 11/10

(57) ABSTRACT

A bendable support device is provided, which includes a support plate, a slidable plate and a pivot mechanism. The support plate has a first portion and a second portion laterally adjacent to the first portion. The slidable plate is disposed over the first portion of the support plate. The pivot mechanism is pivotally connected between the first portion and the second portion. The slidable plate is configured to move toward the pivot mechanism when an angle between a lower surface of the first portion and a lower surface of the second portion is changed from 180 degrees to less than 180 degrees.

### FIELD OF THE INVENTION

The present invention relates to a bendable support device.

### BACKGROUND OF THE INVENTION

In order to provide a user with a comfortable reading angle, a support frame is usually arranged on a back of a tablet. The tablet is properly tilted by bending a portion of the support frame. However, when a bending angle of the support frame is larger, a stretching amount of a surface layer of the support frame facing the tablet is larger, resulting in elastic fatigue, wrinkling or deformation of the surface layer. In addition, due to material properties of the surface layer, the bending angle is limited, and large-angle bending fails to be achieved.

### SUMMARY OF THE INVENTION

The present disclosure provides a bendable support device, which includes a support plate, a slidable plate and a pivot mechanism. The support plate has a first portion and a second portion laterally adjacent to the first portion. The slidable plate is disposed over the first portion of the support plate. The pivot mechanism is pivotally connected between the first portion and the second portion. The slidable plate is configured to move toward the pivot mechanism when an angle between a lower surface of the first portion and a lower surface of the second portion is changed from 180 degrees to less than 180 degrees.

In some embodiments of the present invention, the first portion of the support plate has a recess portion and a groove communicating with the recess portion, and the slidable plate has a main body and a protruding portion protruding laterally from the main body, which are respectively disposed in the recess portion and the groove, and the main body and the protruding portion respectively in the recess portion and the groove are configured to slide toward the pivot mechanism when the included angle is changed from 180 degrees to less than 180 degrees.

In some embodiments of the present invention, the first portion of the support plate further has an opening adjacent to and separated from the groove, and the opening communicates with the groove through the recess portion.

In some embodiments of the present invention, the pivot mechanism includes a pivot shaft, and the slidable plate is configured to move toward the pivot shaft when the included angle is changed from 180 degrees to less than 180 degrees.

In some embodiments of the present invention, the pivot mechanism further includes at least two blades, and one of the at least two blades is disposed between the first portion and the slidable plate.

In some embodiments of the present invention, the support device further includes: a fixed plate disposed over the second portion of the support plate, in which the other of the at least two blades is disposed between the second portion and the fixed plate.

In some embodiments of the present invention, the fixed plate is fixed on the second portion of the support plate, or the fixed plate is integrally formed with the second portion of the support plate.

In some embodiments of the present invention, the support device further includes: an upper surface layer disposed over the slidable plate and the second portion of the support plate, and fixed directly or indirectly on the slidable plate and the second portion of the support plate, in which a portion of the upper surface layer fixed directly or indirectly on the slidable plate is configured to move toward the pivot mechanism together with the slidable plate when the included angle is changed from 180 degrees to less than 180 degrees.

In some embodiments of the present invention, the support device further includes: a lower surface layer disposed beneath the support plate and fixed directly or indirectly on the support plate.

In some embodiments of the present invention, the slidable plate has an extension portion extending downward and adjacent to the pivot mechanism, and a side of the extension portion faces a side of the first portion of the support plate, and the support device further includes: a return mechanism, disposed between the side of the extension portion and the side of the first portion, or disposed on the side of the extension portion and the side of the first portion.

In some embodiments of the present invention, the return mechanism includes an elastic member disposed between the side of the extension portion and the side of the first portion.

In some embodiments of the present invention, the return mechanism includes a pair of attracting magnetic elements respectively disposed on the side of the extension portion and the side of the first portion.

In some embodiments of the present invention, the support device further includes: a return mechanism, including a first magnetic element and a second magnetic element attracting each other, respectively disposed in the slidable plate and in the first portion of the support plate, in which when the included angle is less than 180 degrees, the first magnetic element and the second magnetic element are misaligned; when the included angle is 180 degrees, the first magnetic element is substantially aligned with the second magnetic element.

In some embodiments of the present invention, the support device further includes: a return mechanism, including a second magnetic elements and a third magnetic element repulsing each other, respectively disposed in the first portion of the support plate and in the slidable plate, in which when the included angle is less than 180 degrees, there is a first distance between the second magnetic element and the third magnetic element, and when the included angle is 180 degrees, there is a second distance between the second magnetic element and the third magnetic element, and the first distance is less than the second distance.

### BRIEF DESCRIPTION OF THE DRAWINGS

Aspects of the present invention are best understood from the following embodiments, read in conjunction with the accompanying drawings. It should be understood, however, that in accordance with common practice in the industry, various features have not necessarily been drawn to scale. Indeed, shapes of the various features may be suitably adjusted for clarity, and dimensions of the various features may be arbitrarily increased or decreased.

FIGS. 1A and 1B are schematic cross-sectional views of a support device during an included angle of 180 degrees and less than 180 degrees, respectively, according to an embodiment of the present invention.

FIGS. 2A and 2B are partial cross-sectional schematic views of a support device during an included angle of less than 180 degrees and 180 degrees, respectively, according to an embodiment of the present invention.

FIGS. 3A and 3B are partial cross-sectional schematic views of a support device during an included angle of less than 180 degrees and 180 degrees, respectively, according to an embodiment of the present invention.

FIG. 4 is a perspective view of a support device according to an embodiment of the present invention.

FIG. 5 is an exploded schematic view of the support device of FIG. 4.

FIG. 6 is a schematic cross-sectional view of the support device of FIG. 4.

FIG. 7 is a perspective view of the support plate, the slidable plate, the fixed plate and the pivot mechanism of FIG. 4.

FIGS. 8A and 8B are enlarged schematic views of the slidable plate and a first portion of the support plate of FIG. 4 during an included angle of 180 degrees and less than 180 degrees, respectively.

### DETAIL DESCRIPTION OF THE PREFERRED EMBODIMENT

The advantages and features of the present invention and the method for achieving the same will be described in more detail with reference to exemplary embodiments and the accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180 degrees, the relationship between the one element and the other element may change from “beneath” to “over.” In addition, the spatially relative descriptions used herein should be interpreted the same.

As described in the related art, the existing support frame may cause elastic fatigue, wrinkling or deformation of the surface layer when the bending angle is large. In addition, due to the material properties of the surface layer, the bending angle is limited, and large-angle bending fails to be achieved. Accordingly, the present invention provides a bendable support device to solve the aforementioned issues. Various embodiments of the support device of the present invention will be described in detail below.

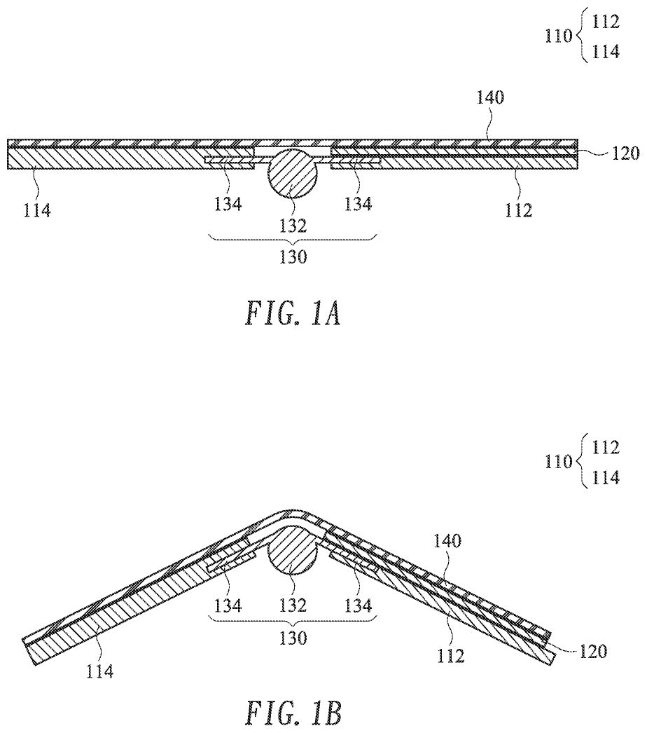

FIGS. 1A and 1B are schematic cross-sectional views of a support device during an included angle of 180 degrees (i.e., the support device is not bent, and a bending angle is 0 degree) and less than 180 degrees (i.e., the support device is bent, and a bending angle is (180 degrees—the included angle)), respectively, according to an embodiment of the present invention. As shown in FIG. 1A, the bendable support device includes a support plate 110, a slidable plate 120 and a pivot mechanism 130. The support plate 110 has a first portion 112 and a second portion 114 laterally adjacent to the first portion 112, and the first portion 112 and the second portion 114 are separated from each other. The support plate 110 may be made of a rigid plastic material or another suitable material. The material of the first portion 112 may be the same as or different from the material of the second portion 114.

The slidable plate 120 is disposed over the first portion 112 of the support plate 110 and is slidable over the first portion 112. The slidable plate 120 may be made of a rigid plastic material or another suitable material.

The pivot mechanism 130 is pivotally connected between the first portion 112 and the second portion 114. The bending of the support device is achieved through the pivot mechanism 130. The pivot mechanism 130 may be, for example, a hinge. The pivot mechanism 130 provides torsional force to allow the support device to have various bending angles (e.g., 30 degrees, 60 degrees, 90 degrees, 120 degrees, 150 degrees or more). It is worth noting that, as shown in FIGS. 1A and 1B, the slidable plate 120 is configured to move toward the pivot mechanism 130 when the support device is bent, that is, when the included angle between a lower surface of the first portion 112 and a lower surface of the second portion 114 (hereinafter referred to as “included angle”) is changed from 180 degrees to less than 180 degrees. In some embodiments, the pivot mechanism 130 includes a pivot shaft 132, and the slidable plate 120 is configured to move toward the pivot shaft 132 when the support device is bent (i.e., when the included angle is changed from 180 degrees to less than 180 degrees). In some embodiments, the pivot mechanism 130 further includes at least two blades 134 disposed between the first portion 112 and the slidable plate 120 and in the second portion 114, respectively. The at least two blades 134 may be glued and fixed on the first portion 112 and in the second portion 114, respectively.

However, when the support device is bent, a portion of the pivot mechanism 130 (e.g., the pivot shaft 132) may be in direct contact with or even hit an electronic device (e.g., a tablet) to cause wear of the electronic device. Therefore, in some embodiments, as shown in FIGS. 1A and 1B, the support device further includes an upper surface layer 140 (or can be called an inner surface layer, which may face the electronic device), which is disposed over the slidable plate 120 and the second portion 114, and is directly or indirectly fixed (e.g., glued) on the slidable plate 120 and the second portion 114 to prevent the portion of the pivot mechanism 130 (e.g., the pivot shaft 132) from directly contacting or even hitting the electronic device, and thus it has the function of protecting the electronic device. The upper surface layer 140 may be made of synthetic leather, natural leather, fiber-containing materials, or other suitable materials. In particular, a portion of the upper surface layer 140 that is directly or indirectly fixed on the slidable plate 120 is configured to move toward the pivot mechanism 130 (e.g., the pivot shaft 132) together with the slidable plate 120 when the support device is bent (i.e., when the included angle is changed from 180 degrees to less than 180 degrees), so a stretching amount of the upper surface layer 140 is very small or even zero at this time, so as to avoid elastic fatigue, wrinkling or deformation of the upper surface layer due to excessive stretching of the upper surface layer, and thus the upper surface layer 140 can still in an unstretched state and maintain its appearance and visual effect during the support device is bent, and the support device can be bent at a large angle.

In some embodiments, when the support device is bent, the movement of upper surface layer 140 can make the slidable plate 120 move toward the pivot shaft 132 together; when the support device is bent back to an original state, a return mechanism may be used to help the slidable plate 120 returns to an original position. Various embodiments of return mechanisms are provided below.

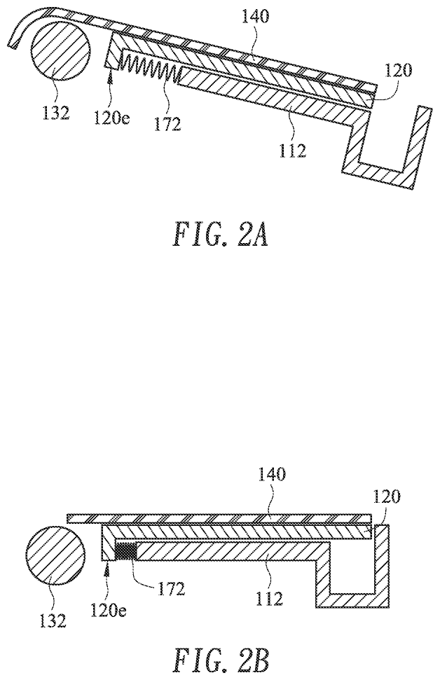

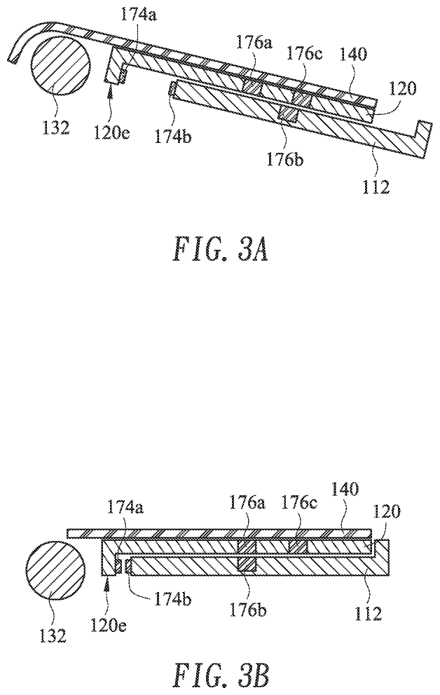

FIGS. 2A and 2B are partial cross-sectional schematic views of a support device during an included angle of less than 180 degrees and 180 degrees, respectively, according to an embodiment of the present invention. FIGS. 3A and 3B are partial cross-sectional schematic views of a support device during an included angle of less than 180 degrees and 180 degrees, respectively, according to an embodiment of the present invention. As shown in FIGS. 2A and 2B and FIGS. 3A and 3B, the slidable plate 120 has an extension portion 120e extending downward and adjacent to the pivot mechanism (e.g., the pivot shaft 132), and one side of the extension portion 120e faces one side of the first portion 112 of the support plate, and the support device further includes a return mechanism, which is disposed between the side of the extension portion 120e and the side of the first portion 112 (refer to FIGS. 2A and 2B), or is disposed on the side of the extension portion 120e and the side of the first portion 112 (refer to FIGS. 3A and 3B).

In some embodiments, as shown in FIGS. 2A and 2B, the return mechanism includes an elastic member 172, which may be, for example, a spring or rubber, disposed between the side of the extension portion 120e and the side of the first portion 112. As shown in FIG. 2A, when the support device is bent (i.e., when the included angle is less than 180 degrees), the elastic member 172 is in a stretched state, and its elastic restoring force can help the extension portion 120e of the slidable plate 120 to return to its original position later; as shown in FIGS. 2A and 2B, when the support device is bent back to its original state (i.e., when the included angle is changed from less than 180 degrees to 180 degrees), the elastic restoring force helps the slidable plate 120 to return to its original position, and the elastic member 172 returns to its original length.

In some embodiments, as shown in FIGS. 2A and 2B, a groove (not marked) is provided on a side of the first portion 112 away from the pivot mechanism (e.g., the pivoting shaft 132), and for the user to place a stylus or other accessories. When the support device is bent, the slidable plate 120 slides toward the pivot shaft 132 to expose the groove, so as to facilitate the user to take out the stylus or other accessories; when the support device is bent back to the original state, the slidable plate 120 returns to its original position and covers the groove to store the stylus or other accessories.

In some embodiments, as shown in FIGS. 3A and 3B, the return mechanism includes a pair of attracting magnetic elements 174a, 174b, which are disposed on the side of the extension portion 120e and on the side of the first portion 112, respectively. As shown in FIG. 3A, when the support device is bent (i.e., when the included angle is less than 180 degrees), the pair of attracting magnetic elements 174a, 174b have a distance, and magnetic attraction force therebetween can help the extension portion 120e of the slidable plate 120 to return later; as shown in FIGS. 3A and 3B, when the support device is bent back to its original state (i.e., the included angle is changed from less than 180 degrees to 180 degrees), the magnetic attraction force helps the slidable plate 120 to return to its original position, and the distance between the attracting magnetic elements 174a, 174b is shortened at this time.

In some embodiments, as shown in FIGS. 3A and 3B, the return mechanism includes a first magnetic element 176a and a second magnetic elements 176b that attract each other, which are respectively disposed in the slidable plate 120 and the first portion 112 of the support plate. As shown in FIG. 3A, when the support device is bent (i.e., when the included angle is less than 180 degrees), the first magnetic element 176a and the second magnetic element 176b are misaligned, and magnetic attraction force therebetween can help the slidable plate 120 to return to its original position later; as shown in FIGS. 3A and 3B, when the support device is bent back to its original state (i.e., when the included angle is changed from less than 180 degrees to 180 degrees), the magnetic attraction force helps the slidable plate 120 to return to its original position, and the first magnetic element 176a is substantially aligned with the second magnetic element 176b at this time.

In some embodiments, as shown in FIGS. 3A and 3B, the return mechanism includes a second magnetic element 176b and a third magnetic element 176c that repulse each other, which are respectively disposed in the first portion 112 of the support plate and in the slidable plate 120. As shown in FIG. 3A, when the support device is bent (i.e., when the included angle is less than 180 degrees), there is a short first distance between the second magnetic element 176b and the third magnetic element 176c, and magnetic repulsion force therebetween can help the slidable plate 120 to return to its original position; as shown in FIGS. 3A and 3B, when the support device is bent back to its original state (i.e., when the included angle is changed from less than 180 degrees to 180 degrees), the magnetic repulsion force helps the slidable plate 120 to return to its original position, and there is a second distance between the second magnetic element 176b and the third magnetic element 176c, and the first distance is smaller than the second distance.

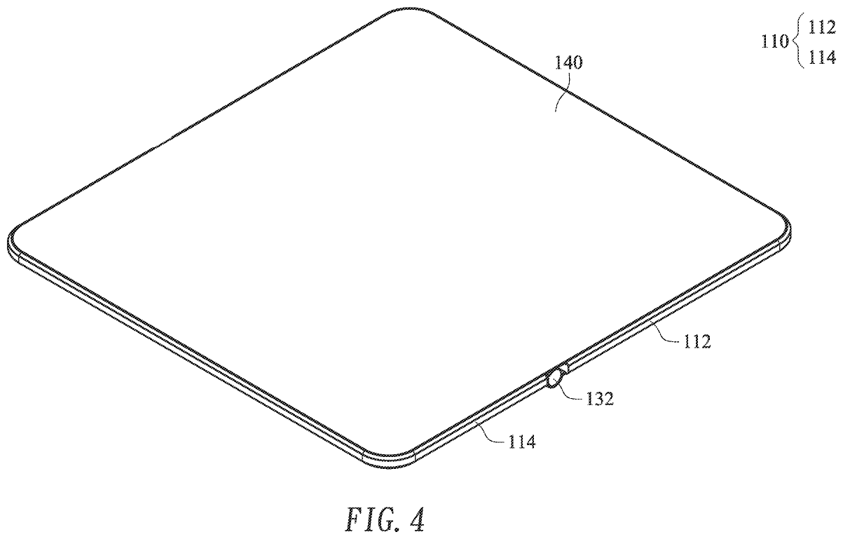

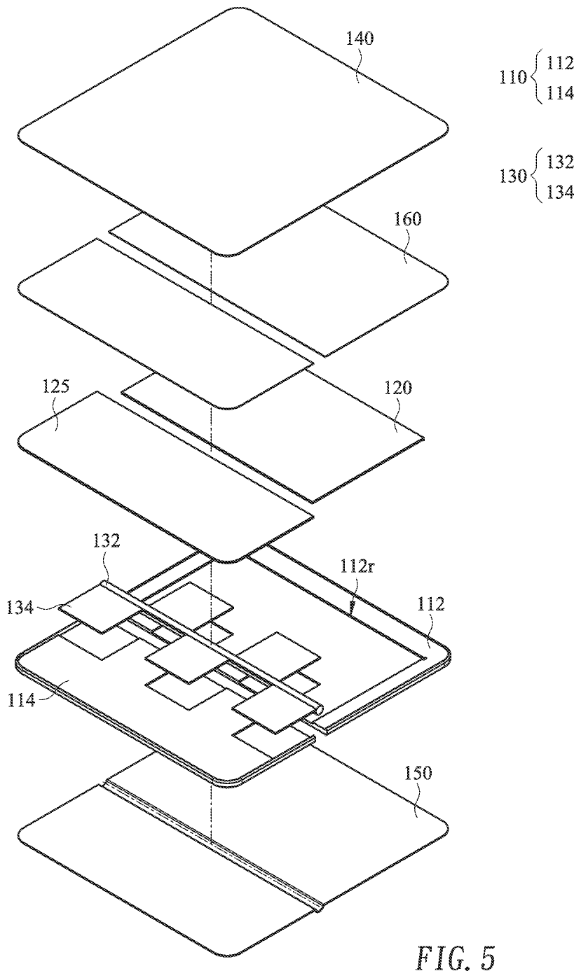

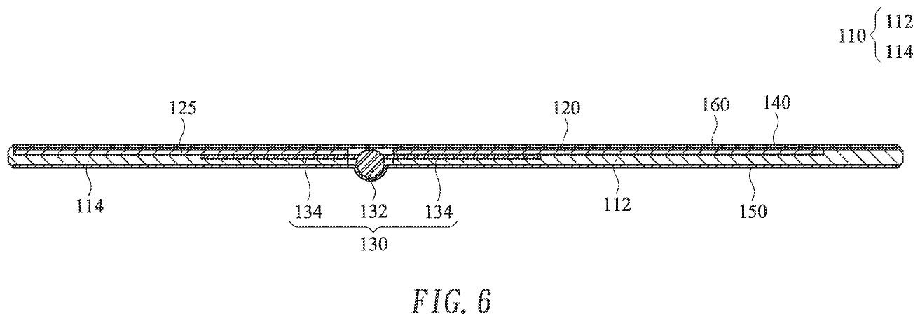

FIG. 4 is a perspective view of a support device according to an embodiment of the present invention. FIG. 5 is an exploded schematic view of the support device of FIG. 4. FIG. 6 is a schematic cross-sectional view of the support device of FIG. 4. The differences between FIGS. 4, 5 and 6 and FIG. 1 are detailed below. As shown in FIGS. 4, 5 and 6, the support device includes not only the support plate 110, the slidable plate 120, the pivot mechanism 130 and the upper surface layer 140 but also a lower surface layer 150 and a cover layer 160. The lower layer 150 is disposed beneath the support plate 110 and is directly or indirectly fixed (e.g., glued) on the support plate 110. The optional cover layer 160 is configured to cover uneven area due to components therebeneath. The cover layer 160 may be made of a composite material (e.g., a fiberglass board) or other suitable material.

In addition, as shown in FIGS. 4, 5 and 6, the support device further includes a fixed plate 125 disposed over the second portion 114 of the support plate 110, and may be fixed (e.g., glued) on the second portion 114 of the support plate 110. The blade 134 is disposed between the second portion 114 and the fixed plate 125 and may be fixed (e.g., glued) between the second portion 114 and the fixed plate 125. The fixed plate 125 may be a single-layer or multi-layer structure, and may be made of a rigid plastic material or another suitable material. In other embodiments, the fixed plate may be integrally formed with the second portion of the support plate, which is equivalent to the second portion 114 of the support plate 110 shown in FIGS. 1A and 1B.

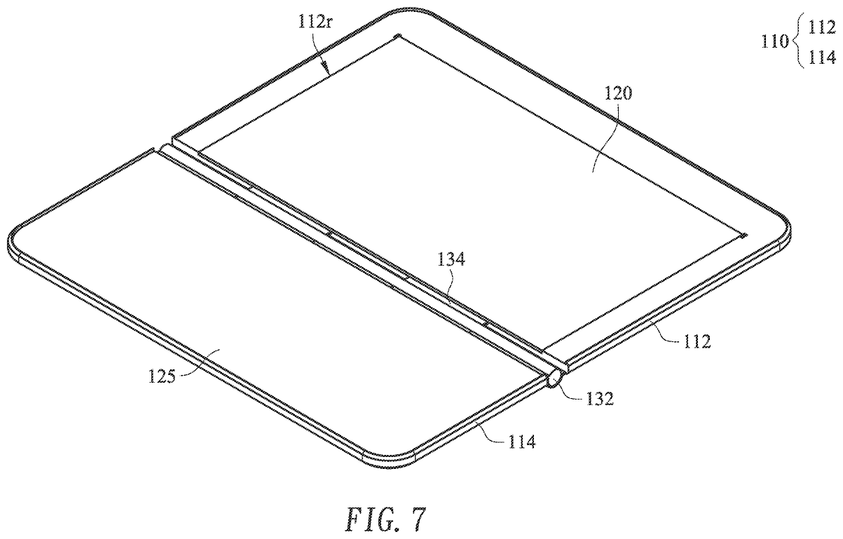

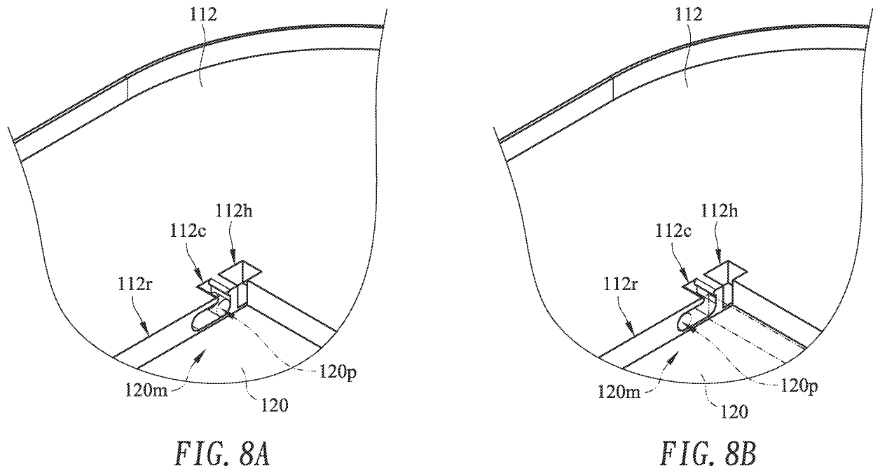

FIG. 7 is a perspective view of the support plate, the slidable plate, the fixed plate and the pivot mechanism of FIG. 4. FIGS. 8A and 8B are enlarged schematic views of the slidable plate (shown in dotted lines) and a first portion of the support plate of FIG. 4 during an included angle of 180 degrees and less than 180 degrees, respectively. As shown in FIGS. 4, 7, 8A and 8B, the first portion 112 of the support plate 110 has a recess portion 112r and a groove 112c communicating with the recess portion 112r, and the slidable plate 120 has a main body 120m and a protruding portion 120p protruding laterally from the main body 120m, which are respectively disposed in the recess portion 112r and the groove 112c. The main body 120m and the protruding portion 120p respectively in the recess portion 112r and the groove 112c are configured to slide toward the pivot mechanism 130 (e.g., the pivot shaft 132) when the support device is bent (i.e., when the included angle is changed from 180 degrees to less than 180 degrees). A sliding direction of the slidable plate 120 is completely perpendicular or substantially perpendicular to an extending direction of the pivot shaft 132.

As shown in FIGS. 8A and 8B, the first portion 112 of the support plate 110 further has an opening 112h adjacent to and separated from the groove 112c, and the opening 112h communicates with the groove 112c through the recess portion 112r. The opening 112h is configured to make a sidewall of the groove 112c adjacent to the opening 112h elastic, so that the protruding portion 120p of the slidable plate 120 can be smoothly inserted into the groove 112c. However, based on the design of an open end of the groove 112c, the protruding portion 120p will not fall out from the open end of the groove 112c.

As can be seen from the above, the present invention is provided with the slidable plate, so that when the support device is bent, the stretching amount of the upper surface layer is very small or even zero, so as to avoid elastic fatigue, wrinkling or deformation of the upper surface layer due to excessive stretching of the upper surface layer, and thus the upper surface layer 140 can still in an unstretched state and maintain its appearance and visual effect during the support device is bent, and the support device can be bent at a large angle.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not used to limit the scope of claims of the present invention.

What is claimed is:

1. A bendable support device, comprising:
a support plate having a first portion and a second portion laterally adjacent to the first portion;
a slidable plate disposed over the first portion of the support plate; and
a pivot mechanism pivotally connected between the first portion and the second portion;
wherein the slidable plate is configured to move toward the pivot mechanism when an included angle between a lower surface of the first portion and a lower surface of the second portion is changed from 180 degrees to less than 180 degrees.

2. The support device of claim 1, wherein the first portion of the support plate has a recess portion and a groove communicating with the recess portion, and the slidable plate has a main body and a protruding portion protruding laterally from the main body, which are respectively disposed in the recess portion and the groove, and the main body and the protruding portion respectively in the recess portion and the groove are configured to slide toward the pivot mechanism when the included angle is changed from 180 degrees to less than 180 degrees.

3. The support device of claim 2, wherein the first portion of the support plate further has an opening adjacent to and separated from the groove, and the opening communicates with the groove through the recess portion.

4. The support device of claim 1, wherein the pivot mechanism comprises a pivot shaft, and the slidable plate is configured to move toward the pivot shaft when the included angle is changed from 180 degrees to less than 180 degrees.

5. The support device of claim 1, wherein the pivot mechanism further comprises at least two blades, and one of the at least two blades is disposed between the first portion and the slidable plate.

6. The support device of claim 5, further comprising:
a fixed plate disposed over the second portion of the support plate, wherein the other of the at least two blades is disposed between the second portion and the fixed plate.

7. The support device of claim 6, wherein the fixed plate is fixed on the second portion of the support plate, or the fixed plate is integrally formed with the second portion of the support plate.

8. The support device of claim 1, further comprising:
an upper surface layer disposed over the slidable plate and the second portion of the support plate, and fixed directly or indirectly on the slidable plate and the second portion of the support plate, wherein a portion of the upper surface layer fixed directly or indirectly on the slidable plate is configured to move toward the pivot mechanism together with the slidable plate when the included angle is changed from 180 degrees to less than 180 degrees.

9. The support device of claim 1, further comprising:
a lower surface layer disposed beneath the support plate and fixed directly or indirectly on the support plate.

10. The support device of claim 1, wherein the slidable plate has an extension portion extending downward and adjacent to the pivot mechanism, and a side of the extension portion faces a side of the first portion of the support plate, and the support device further comprises:
a return mechanism, disposed between the side of the extension portion and the side of the first portion, or disposed on the side of the extension portion and the side of the first portion.

11. The support device of claim 10, wherein the return mechanism comprises an elastic member disposed between the side of the extension portion and the side of the first portion.

12. The support device of claim 10, wherein the return mechanism comprises a pair of attracting magnetic elements respectively disposed on the side of the extension portion and the side of the first portion.

13. The support device of claim 1, further comprising:
a return mechanism, comprising a first magnetic element and a second magnetic element attracting each other, respectively disposed in the slidable plate and in the first portion of the support plate, wherein when the included angle is less than 180 degrees, the first magnetic element and the second magnetic element are misaligned; when the included angle is 180 degrees, the first magnetic element is substantially aligned with the second magnetic element.

14. The support device of claim 1, further comprising:
a return mechanism, comprising a second magnetic elements and a third magnetic element repulsing each other, respectively disposed in the first portion of the support plate and in the slidable plate, wherein when the included angle is less than 180 degrees, there is a first distance between the second magnetic element and the third magnetic element, and when the included angle is 180 degrees, there is a second distance between the second magnetic element and the third magnetic element, and the first distance is less than the second distance.
